(19) United States
(12) Patent Application Publication
(10) Pub. No.: US 2020/0300699 A1
(43) Pub. Date: Sep. 24, 2020

(54) METHOD AND APPARATUS FOR LINEAR VARIABLE BANDPASS FILTER ARRAY OPTICAL SPECTROMETER

(71) Applicant: WESTBORO PHOTONICS INC., Ottawa (CA)

(72) Inventor: TIMOTHY MOGGRIDGE, OTTAWA (CA)

(21) Appl. No.: 16/826,401

(22) Filed: Mar. 23, 2020

Related U.S. Application Data
(60) Provisional application No. 62/821,895, filed on Mar. 21, 2019.

(51) Int. Cl. G01J 3/28; G01J 3/02

(52) U.S. Cl. CPC G01J 3/2803; G01J 3/0229; G01J 2003/2813; G01J 2003/2806; G01J 3/0218

(57) ABSTRACT

An apparatus and method for a linear variable bandpass filter spectrometer with a wide spectral range is disclosed. More specifically, the present invention is comprised of a two-dimensional photodetector array optically coupled to two or more linear variable bandpass filters with different spectral ranges or two stacked filters with the same spectral ranges.

### TECHNICAL FIELD

The subject matter of the present invention relates to a system and method for an optical spectrometer with an extended spectral range, extended dynamic range and improved stray light performance utilizing one or a plurality of linear variable bandpass filters optically coupled to a two-dimensional photodetector array.

### BACKGROUND

An optical spectrometer includes any electro-optical instrument that measures the relative or absolute spectral power distribution of electromagnetic radiation incident upon the instrument's input optics. A compact spectrometer incudes any portable spectrometer. A spectroradiometer is a spectrometer that has been calibrated in terms of radiometric units.

Compact spectrometers using linear variable bandpass filters (“LVBF”) and photodetectors arrays have previously been proposed (e.g., Dami, M., et al. 2010, “Ultracompact Spectroradiometer Using Variables Filters,” Proc. SPIE Vol. 10565 1056559-1), wherein the LVBFs are multilayer interference filters achieved by depositing a multitude of thin-film dielectric and metal layers (typically 30 or more) on a transparent substrate such as fused quartz. The thicknesses of the layers are varied across the length of the filter, such that a narrow bandpass whose center wavelength varies by up to a spectral octave across the length of the filter can be achieved (e.g., FIG. 1). The full-width-half-maximum (FWHM) spectral bandwidth may be as narrow as 1.5 percent of the center wavelength, resulting in bandpass values of 6 nm at 400 nm to 10.5 nm at 700 nm. While these bandpass values are not as narrow as can be achieved with diffraction grating-based spectrometers, they are adequate for many applications.

A diffraction grating, as known to one skilled in the art, includes an optical component with a periodic structure that splits and diffracts light into several beams travelling in different directions wherein the emerging coloration is a form of structural coloration. In the context of this disclosure, a diffraction grating may also refer to a prism or any other means of spreading light into different colors for analysis.

It is possible to mass-produce LVBFs as small as 3 mm that span the visible spectrum (e.g., Turner, T. et al. 2016. “For Compactness and Ruggedness, Linear Variable Filters Fit the Bill,” Photonics Spectra September 2016) using ion beam sputtering with proprietary plume-shaping technology. These filters can be combined with optical detector arrays such as CMOS or CCD array sensors to realize a compact optical spectrometer. Very small LVBF spectrometers as described by Turner et al. also have a physically narrow virtual slit that may limit the radiation throughput and hence the achievable signal-to-noise (S/N) ratio.

Another disadvantage of LVBFs is that their spectral range is typically not more than one spectral octave. Such a typical spectral range may be defined wherein the longest wavelength, λ_{MAX}, is twice or less than the shortest wavelength, λ_{MIN}, such as for example 400 nm to 700 nm (VIS) or 750 nm to 1100 nm (NIR). It is not feasible to produce a LVBF with a larger spectral range, such as for example 350 nm to 1000 nm (UV-VIS-IR).

Another disadvantage is that LVBFs are usually made in specific sizes. Getting a custom filter size to fit a desired detector and transmission specification for the application may be very time consuming and expensive.

### SUMMARY OF INVENTION

The inventor has recognized that there are many applications that could benefit from a spectrometer with a wide spectral range, such as for example 350 nm to 1000 nm. There is therefore a need for a compact spectrometer comprising an LVBF with an extended spectral range and high optical radiation throughput such that a high S/N ratio from the photodetector array can be achieved. Compared to conventional diffraction grating spectrometers, such a compact instrument could be an order of magnitude smaller and much more physically robust.

Typical LVBF spectrometers may be much larger and more expensive than necessary as custom design of LVBFs is time consuming and expensive. The proposed design provides flexibility in the sizes of the LVBF segments, so that even wide wavelength range assemblies can be fit onto very small sensors. The invention allows the optimal mixing and matching of available off-the-shelf LVBF components and array sensors to optimize design parameters such as cost and technical performance.

Disclosed herein is an apparatus comprising a spectrometer with an extended spectral range coupled to two or more linear variable bandpass filters; and optically coupled to a two-dimensional photodetector array. Also disclosed are methods to increase functionality, extend and improve UV (ultra-violet) performance, reduce stray light, reduce bandwidth and increase dynamic range in a spectrometer utilizing variable bandpass filters and a two-dimensional photodetector array.

### BRIEF DESCRIPTION OF DRAWINGS

FIG. 1 (prior art) illustrates spectral transmittance of prior art visible light/near infrared (VIS-NIR) linear variable bandpass filters with bandpass measurements at a multitude of center wavelengths.

FIG. 2 illustrates an LVBF that has been scribed along its length prior to dicing.

FIG. 3 illustrates an LVBF that has been diced into segments with shorter spectral ranges wherein the peak transmission wavelength varies from left to right but not from top to bottom.

FIG. 4 illustrates a two dimensional (“2D”) photodetector array that has been optically coupled to five LVBF segments with differing spectral ranges wherein the peak transmission wavelength varies along the longest lengths (front to back in the image) of each filter segment.

FIG. 5 illustrates a 2D photodetector array that has been optically coupled to five LVBF segments with differing spectral ranges, wherein each of the five LVBFs has vertical light baffles attached between the segments.

FIG. 6 illustrates a 2D photodetector array that has been optically coupled to a stack of two identical layers of filters wherein each layer has five unique LVBF segments.

FIG. 7 illustrates a 2D photodetector array that has been optically coupled to a stack of two identical layers of filters, with tilting between the filters of one layer and the other.

FIG. 8 illustrates a 2D photodetector array that has been optically coupled to a stack of two identical layers of filters, each layer having five unique LVBF segments and each of the five LVBFs has vertical light baffles attached between the segments.

FIG. 9 illustrates a 2D photodetector array that has been optically coupled to five LVBF segments with differing spectral ranges and a single optical attenuation filter.

FIG. 10 illustrates a 2D photodetector array that has been optically coupled to a plurality of LVBF segments with differing spectral ranges and two optical attenuation filters.

FIG. 11 Illustrates a 2D photodetector array with three LVBF segments, three non-LVBF filters and an area with no filter.

FIG. 12 illustrates the shift in center wavelength of an LVBF with angle of incidence of the optical radiation.

FIG. 13 illustrates in linear scale the normalized transmission functions for a typical bandpass filter (dashed line) and the transmission function for two filters that are stacked together in series (solid line).

FIG. 14 illustrates in logarithmic scale the normalized transmission functions for a typical bandpass filter (dashed line) and the transmission function for two filters that are stacked together in series (solid line).

FIG. 15 illustrates in linear scale the normalized transmission functions for two filters that are shifted spectrally (dashed lines) and the composite filtering when the two filters are stacked together in series (solid line).

FIG. 16 illustrates in logarithmic scale the normalized transmission functions for two filters that are shifted spectrally (dashed lines) and the composite filtering when the two filters are stacked together in series (solid line).

FIG. 17 illustrates a light beam coming from an off-axis direction onto a stack of two LVBFs.

FIG. 18 illustrates in log scale a possible transmission function for the two thin films as they are illuminated in FIG. 17 (dashed lines). The composite filtering of the light ray reaching the detector is significantly attenuated (solid line).

FIG. 19 illustrates irradiance of the LVBF spectrometer assembly by a distant point source of optical radiation.

FIG. 20 is an LVBF spectrometer assembly optically coupled to an optically absorbing baffle assembly.

FIG. 21 is an LVBF spectrometer assembly optically coupled to an optical train.

FIG. 22 illustrates an LVBF spectrometer assembly optically coupled to a light guide.

FIG. 23 shows an LVBF spectrometer assembly optically coupled to an integrating sphere.

FIG. 24 illustrates a spectrometer comprising two identical LVBF filters that are tilted relative to one another. The spectrometer is illuminated with collimated radiation.

FIG. 25 illustrates that the UV LVBF with attached UV enhancement film can be mated to a non-UV array sensor.

FIG. 26 describes a general calibration process for calibration of an LVBF spectrometer.

FIG. 27 illustrates a multi-segment LVBF spectrometer.

FIG. 28 illustrates a zoomed-in portion of FIG. 27 showing columns of pixels mapped to a single wavelength value during the calibration process.

FIG. 29 illustrates a zoomed in portion of FIG. 27 where the pixels mapped to a single wavelength are not in a straight column.

FIG. 30 illustrates an LVBF assembly with a plurality of LVBF segments and some additional measurement areas on the sensor for other filtered light measurements and an area on the sensor that is dedicated to detecting the light without any additional light filtering.

FIG. 31 (prior art) describes a process for wavelength calibration of an array spectrometer.

FIG. 32 describes a process for wavelength calibration of an LVBF spectrometer.

FIG. 33 illustrates a detector array optically coupled to an LVBF and an attenuating (density) filter assembly where the attenuating filter provides a plurality of transmission values at each wavelength of the LVBF. The attenuating filter may be a variable attenuating filter or two or more filters assembled in an array. The attenuating filter can be optically bonded, deposited or positioned in close proximity to the LVBF.

FIG. 34 illustrates a spectrometer comprising an entrance slit, collimating optics, dispersing element, focusing optics, and a filtered detector assembly comprising attenuating (density) filter, an LVBF, and an optical detector array.

### DETAILED DESCRIPTION

Glossary—Extended Spectral Range, as used herein, refers to a spectral range that is equal to or greater than one spectral octave, i.e. the longer wavelength limit is at least twice as great as the shorter wavelength limit.

The invention disclosed herein includes an apparatus comprised of a two-dimensional (2D) photodetector array with CCD, CMOS, InGaAs, HgCdTe, quantum dot, or similar sensors optically coupled to two or more linear variable bandpass filters, and optionally, one or more optical attenuation filters, and optionally an optical radiation mixing device such a diffuser, integrating sphere, scattering cavity, or fiber optic light guide.

Commercially-available LVBFs typically measure 60 mm long by 29 mm wide, with the center wavelength varying along their length. Spectral ranges typically span less than an octave, such as 400 nm to 700 nm for visible light or 790 nm to 1100 nm for near-infrared radiation. In general, an LVBF may have a spectral range anywhere within the range of optical radiation, defined herein as having the wavelength range of 100 nm (ultraviolet-C) to 12 μm (far-infrared radiation).

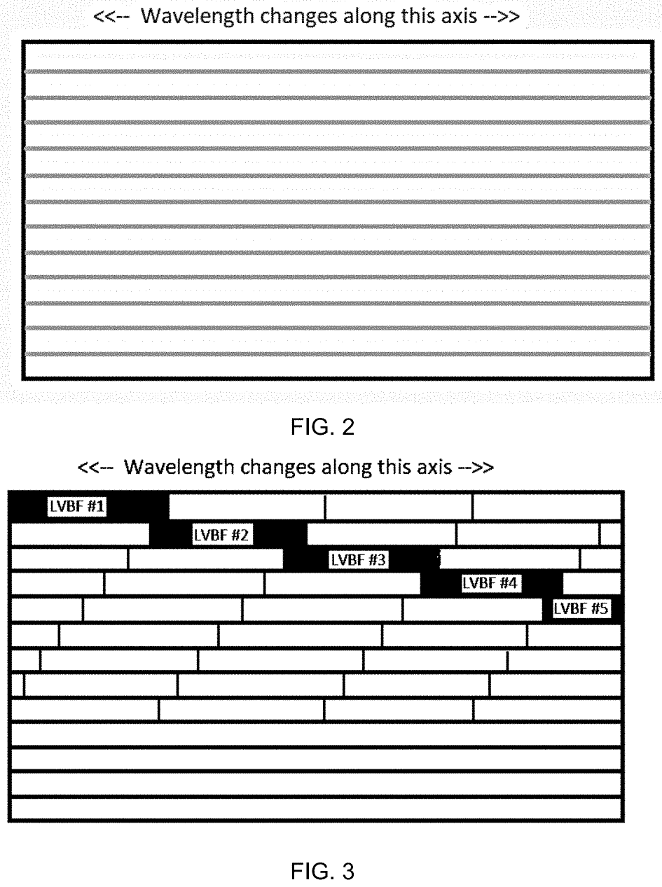

In FIG. 2, an LVBF has been scribed lengthwise into parallel strips for the purpose of dicing using a wafer dicing process. This process can include scribing and breaking, mechanical sawing with a dicing saw, or laser cutting.

In FIG. 3, parallel strips of the LVBF are further cut into shorter segments with different spectral ranges, identified in the drawing as LVBF #1 through LVBF #5 for illustration purposes only. Multiple LVBFs with different spectral ranges, lengths and widths may be similarly diced. The multiple LVBFs may also have different bandpass characteristics, transmission characteristics, or any other parameter. Combined, the LVBF spectrometer will have many detector elements with unique spectral, bandpass and sensitivity attributes. And, the segments are assembled not exclusively end-to-end to create one continuous wavelength range, but rather the segments may be stacked such that there are disparate wavelengths in a significant portion of the detector's columns and rows of detector pixels. By disparate, it is meant wavelengths differ by more than ten times the LVBF's nominal full width half maximum (FWHM). For some embodiments, the total spectral range of the assembly of LVBF segments could exceed the spectral octave limit of a single LVBF. For example, an ultraviolet-sensitive CMOS or CCD sensor with a spectral range of 200 nm to 1100 nm can be fabricated with LVBF segments derived from three LVBFs that together cover the 200 nm to 1100 nm wavelength range. In other embodiments, there may be LVBF segments sourced covering overlapping wavelength regions with different bandpass values or transmission values in order to create a spectrometer with the required attributes for a specific application.

Conventional CCD and CMOS imaging devices do not detect radiation in the UV region because of high absorption of short wavelength radiation near the surface of the sensor. Electrons are, therefore, not generated in the deeper-down, active part of the sensor. There are a number of solutions to the problem, including custom design and back-thinning of conventional devices, but these options can be expensive. A cost-effective alternative is to spectrally shift the silicon device's response to the blue region by coating them with a suitable phosphor or quantum dot material that will be excited by the UV radiation and then re-emit in longer wavelengths of light that are readily detected by the photodetector array.

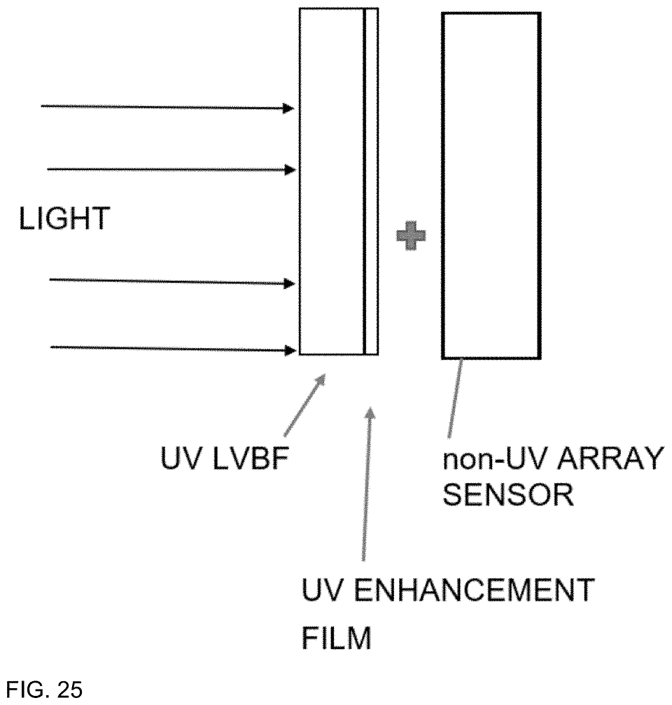

Embodiments of the invention, to extend the UV performance of the LVBF spectrometer, include the application of a UV enhancement (phosphor or quantum dot) coating (or film) between the UV sections of LVBF and the photodetector array. This can be achieved by putting a thin sheet of material containing the phosphor or quantum dots between the two layers, or by coating either the sensor or the LVBF with the UV enhancement material. An LVBF coated with the UV enhancement coating will spectrally and spatially transmit unique bands of UV radiation and convert that UV light to longer wavelengths of light that can be sensed by the array detector. See FIG. 25. Similarly, other phosphors and coatings may convert shorter wavelengths to longer wavelengths such as visible to IR. It may also be possible to use an IR (infrared) enhancement coating or film that that up-converts long-wavelength IR radiation to shorter-wavelength IR or visible radiation. Image intensifiers may be used to upconvert or down-convert light wavelengths. Up-converting phosphors may be used—for example new technology that may still be in its infancy based on biological systems. In addition, there are supercontinuum lasers that emit shorter wavelengths than the pump laser.

The parallel strips of the LVBFs shown in FIG. 3 have overlapping spectral ranges, but this is not a requirement; the sum of the spectral ranges of two or more segments, whether from one or more LVBFs, may be continuous or discontinuous.

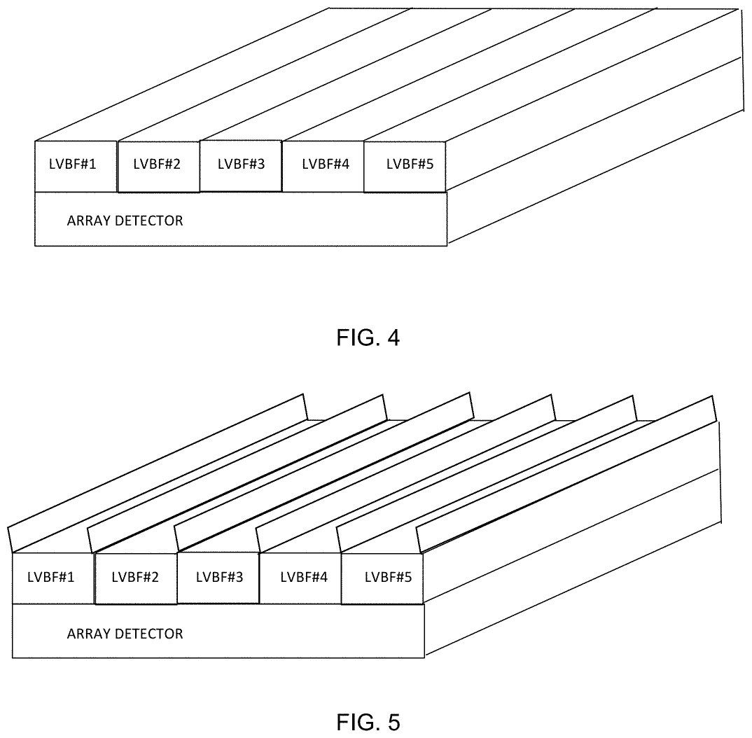

In FIG. 4, the LVBF segments are optically coupled to a 2D photodetector array that is responsive to optical radiation, the optical detector array located to detect optical radiation passing through the LVBF. In one embodiment, the segments are optically bonded to each other with an optical adhesive having substantially the same index of refraction as the transparent LVBF substrate over the spectral range of interest. In another embodiment, the segments are separated from each other by an opaque adhesive. In some embodiments, the LVBF segments are arranged in an array that has two or more segments along each direction of the array.

The optical coupling between the LVBF segments and the photodetector may comprise direct bonding with an optical adhesive or be separated by an air or vacuum gap or an index-matching fluid or gel.

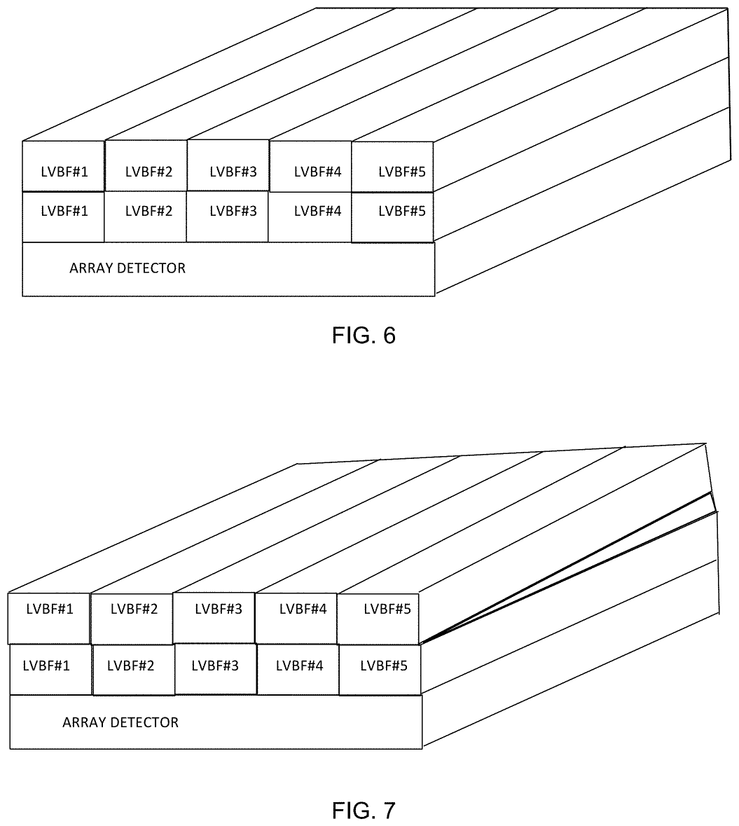

In another embodiment (FIGS. 6, 7 and 8), two identical LVBF segment assemblies are stacked to increase the spectrometer dynamic range. If for example a single LVBF has a stray light rejection outside of its bandpass of 10E-5, two identical stacked LVBFs would have enhanced stray rejection of 10E-10 and a narrower full width at half maximum (FWHM) transmission. In FIGS. 6, 7 and 8, examples are shown with five LVBFs in each layer of the filter stack. The stacking in this way could have one or more filters in each layer of the filter stack.

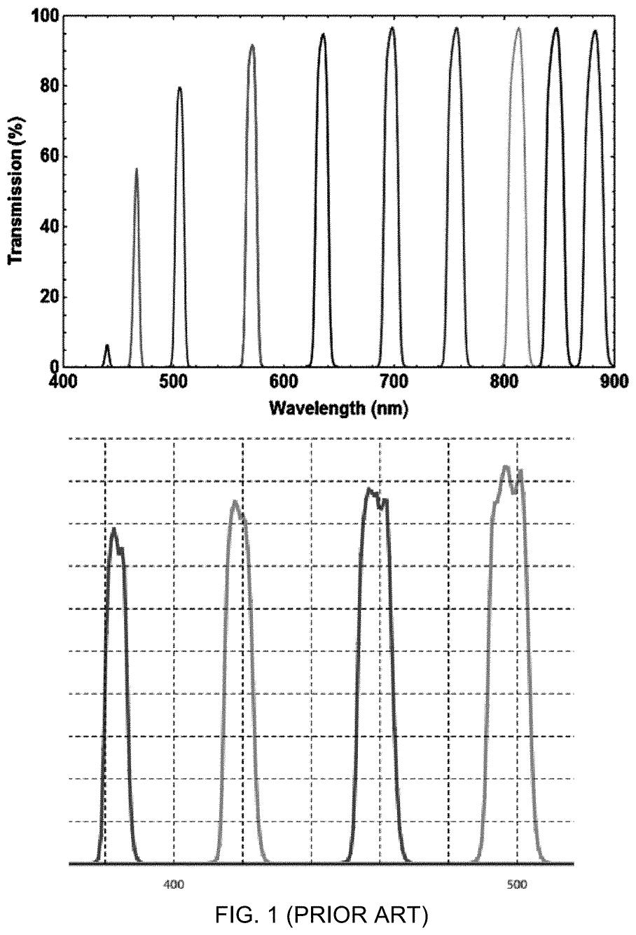

It is desirable to have a smooth and symmetrical bandpass shape. However, design criteria favoring very high out of band rejection filters may compromise the bandpass shape; and a bumpy nature to the filter function is common (FIG. 1). Stacking two filters which are nearly, but not identical, or identical, but not precisely lined may help to make the bandpass function smoother.

In another embodiment (not shown), a linearly variable longpass filter, or a linearly variable shortpass filter could be mounted over the LVBF(s). These longpass or shortpass filters can enhance spectral stray light performance.

In another embodiment, a two-filter stack (FIG. 6) has one filter layer that is slightly mis-aligned as compared to the other so that the peak transmission wavelengths do not exactly match up. In this case, the transmission of the assembly could also have a narrower bandpass or lower transmission than either of the two component filters alone or if the two were perfectly aligned.

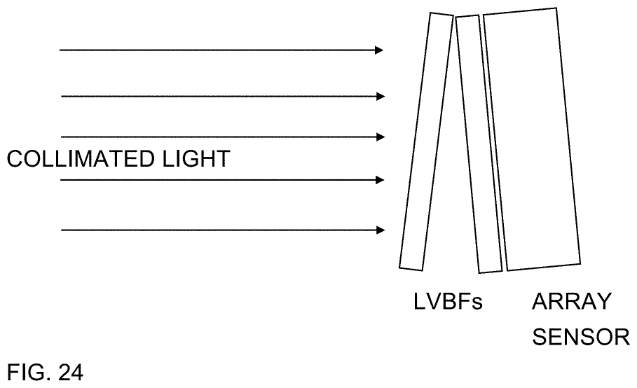

The filter layers may also be tilted with respect to each other, or with respect to the array detector as in FIGS. 7 and 24. The tilting may be along either axis of the LVBF as long as the filters are more or less aligned vertically. Tilting in this way may help to reduce retroreflection to highly collimated sources such as lasers. Tilting also changes the shape of the transmission function. Tilting two identical filters as in FIG. 24 may be useful to reduce the size of and improve the shape of the bandpass function as compared to the embodiment in FIG. 6.

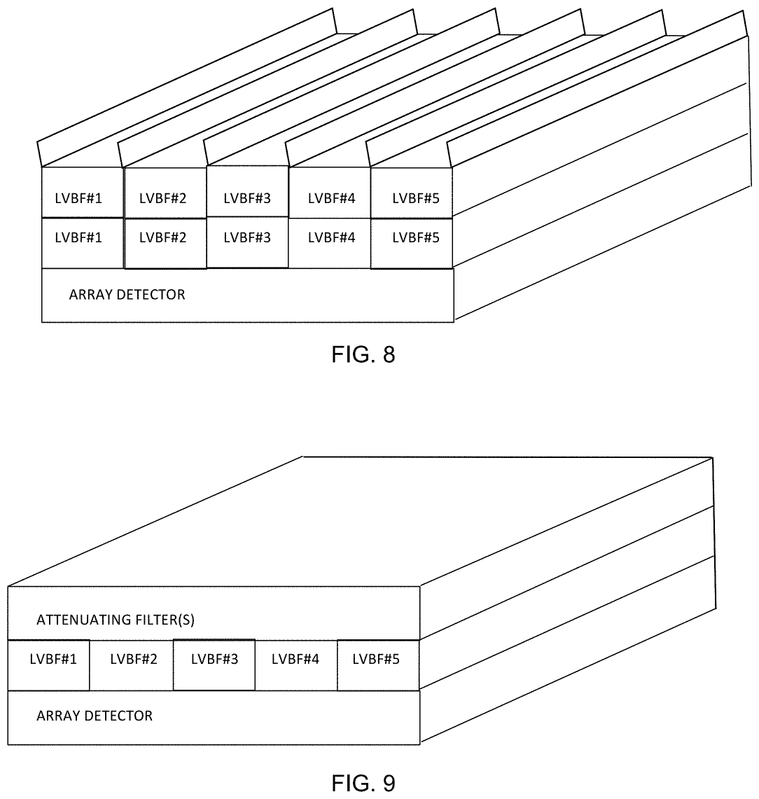

FIGS. 5 and 8 are embodiments which further reduce light from oblique angles from entering the assembly. In FIGS. 5 and 8 vertical baffles are installed between, beside and above the LVBF segments. These baffles remove unwanted illumination angles of light coming from oblique angles of incidence. Without baffling, these oblique rays could have unwanted spectral weighting through the LVBF segment(s). Baffles could be assembled on top of the filter assembly using a milk crate arrangement, or they could be affixed between each filter segment. FIG. 5 illustrates a 2D photodetector array that has been optically coupled to five LVBF segments, wherein each of the five LVBFs has vertical light baffles attached between, beside and above the segments. FIG. 8 illustrates a 2D photodetector array that has been optically coupled to a stack of two identical layers of filters, each layer having five unique LVBF segments and each of the five LVBFs has vertical light baffles attached between, beside and above the segments.

In FIG. 9, the LVBF segments are further bonded to at least one optional optical filter such as for example dyed glass, a linear polarizer, a polarization retarder, a dyed polymer film, a semitransparent metal film evaporated onto a glass or polymer substrate, or a multilayer thin film interference filter. The filters may exhibit any spectral transmittance distribution, and multiple filters may be stacked. The filters may also have antireflection coatings to minimize optical radiation losses due to Fresnel reflection. The attenuating filter could also have varying transmission over its area thereby providing an extended range of sensitivities for the photodetector array. One purpose of using a variable attenuator would be to increase the dynamic range of the spectrometer with a single exposure. The attenuation filter could also be a linearly variable longpass filter, or a linearly variable shortpass filter. In another embodiment the attenuating filter could be mounted below the LVBF and next to the array detector.

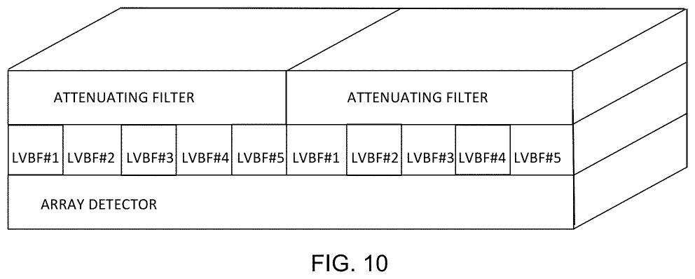

In FIG. 10, the LVBF segments are further bonded to at least two optional optical filters that are arranged side-by-side, wherein the filters may have different spectral transmittance distributions. One purpose of such an assembly could be to increase the dynamic range of the spectrometer with a single exposure.

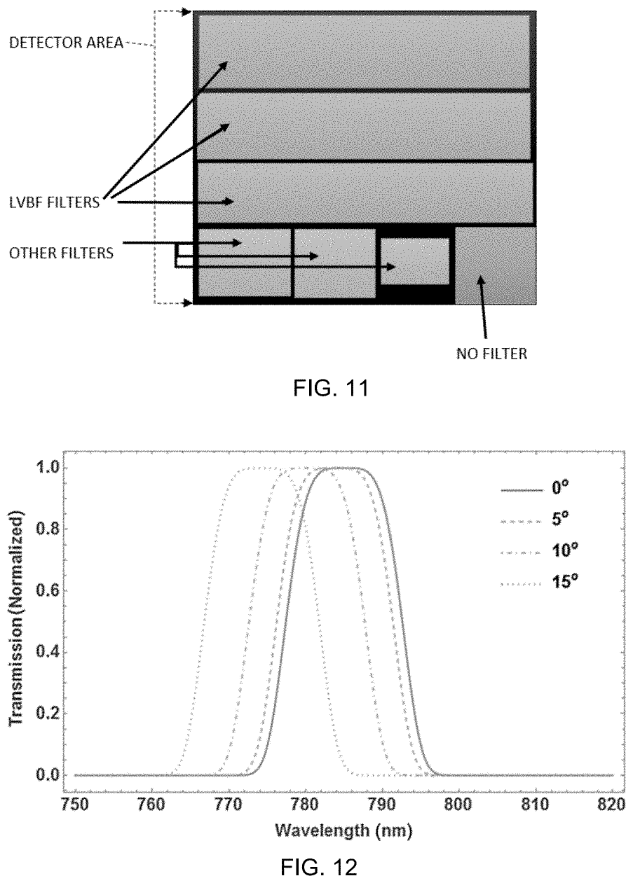

FIG. 11 Illustrates a 2D photodetector array with three LVBF segments, three non-LVBF filters and an area with no filter.

As will be known to those skilled in the art, the spectral transmittance distribution of a multilayer interference filter, including LVBFs, is dependent upon the angle of incidence of the optical radiation (e.g., Renhorn, I. G. E., et al. 2016. “High Spatial Resolution Hyperspectral Camera Based on a Linear Variable Filter,” Optical Engineering 55(11):114105.), according to:

$$\frac{Δ λ}{λ} = \sqrt{1 - \frac{{sin}^{2} θ}{{η}^{2}}} - 1 \qquad ( 1 )$$

where θ is the angle of incidence, η is the refractive index of the filter, and λ is the wavelength at normal incidence (i.e., 0=0). As shown in FIG. 12 for example (from FIG. 5 of Renhorn et al. 2016), a change in the angle of incidence from 0 degrees (i.e., normal to the LVBF surface) to 15 degrees results in a center wavelength shift of approximately 15 nm at 785 nm with a FWHM bandwidth of 16 nm.

To obtain the narrowest possible FWHM bandwidth for the LVBF segments, it is therefore necessary to ensure that the incident optical radiation is collimated. However, in the event that this is not possible, Equation 1 enables the spectrometer bandwidth to be calculated as a function of the center wavelength, albeit by taking optical train vignetting and angle-dependent Fresnel reflection into account.

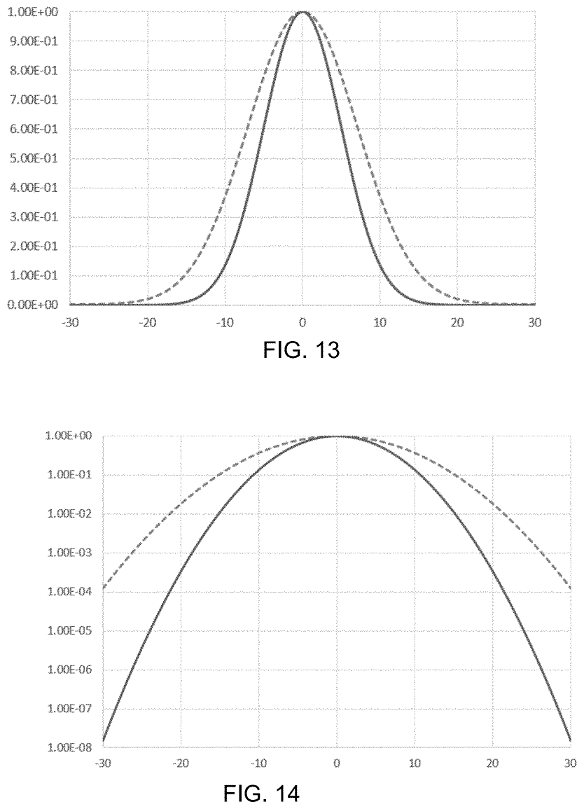

FIG. 13 illustrates in linear scale the normalized transmission functions for a typical bandpass filter (dashed line) and the transmission function for two filters that are stacked in series (solid line).

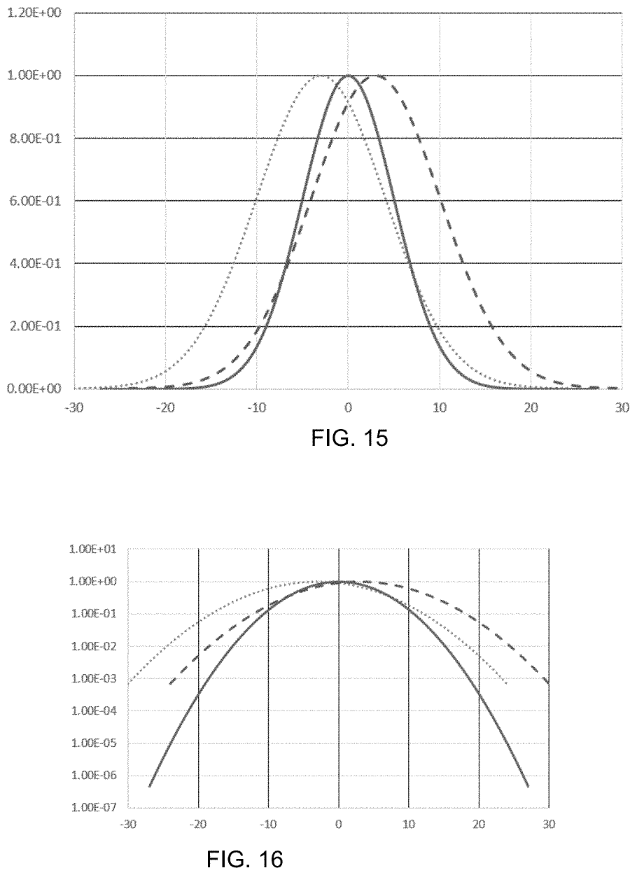

FIG. 15 illustrates in linear scale the normalized transmission functions for two filters that are shifted spectrally (dashed lines) and the composite filtering when the two filters are stacked together in series (solid line).

FIG. 16 illustrates in logarithmic scale the normalized transmission functions for two filters that are shifted spectrally (dashed lines) and the composite filtering when the two filters are stacked together in series (solid line).

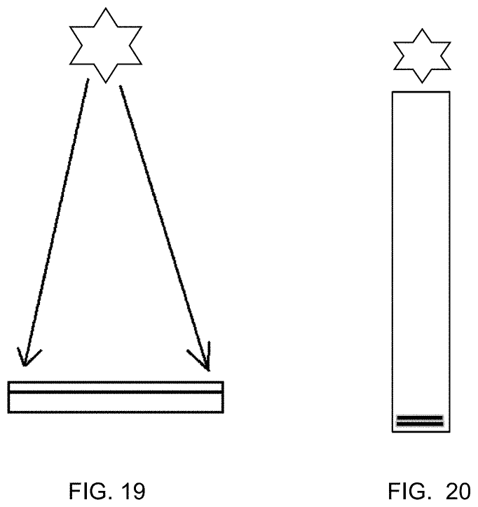

FIG. 19 illustrates irradiation of an LVBF spectrometer assembly with a distant point source of optical radiation, wherein the incident radiation is substantially collimated.

FIG. 20 illustrates an LVBF spectrometer assembly optically coupled to an optically absorbing baffle assembly such that the optical radiation incident upon the LVBF is substantially collimated.

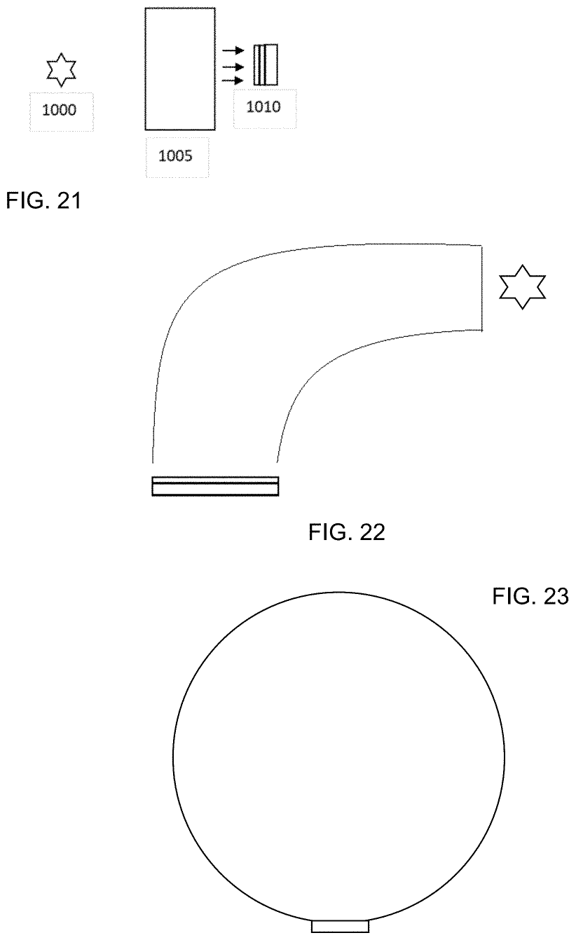

FIG. 21 illustrates an LVBF spectrometer assembly optically coupled to an optical train such that the optical radiation incident upon the LVBF is substantially collimated. The optical train may be comprised of refractive, reflective, and/or diffractive elements.

FIG. 22 illustrates an LVBF spectrometer assembly optically coupled to an optical radiation light guide. In one embodiment, the light guide is comprised of a fiber optic bundle with a numerical aperture:

$$n . a . = \frac{1}{{η}_{0}} \sqrt{{η}_{core}^{2} - {η}_{cl adding}^{2}} \qquad ( 2 )$$

where η_{core} is the refractive index of the fiber core, η_{cladding} is the refractive index of the fiber cladding, and no is the refractive index of the surrounding medium. The maximum angle of exitance from the fiber optic bundle and thus incident upon the LVBF spectrometer assembly is the arcsine of the numerical aperture.

FIG. 23 illustrates an LVBF spectrometer assembly optically coupled to an integrating sphere. As shown, the maximum angle of incidence upon the LVBF spectrometer assembly is 90 degrees. However, an optical baffle assembly or optical train may be interposed between the integrating sphere port and LVBF spectrometer assembly to limit the maximum angle of incidence.

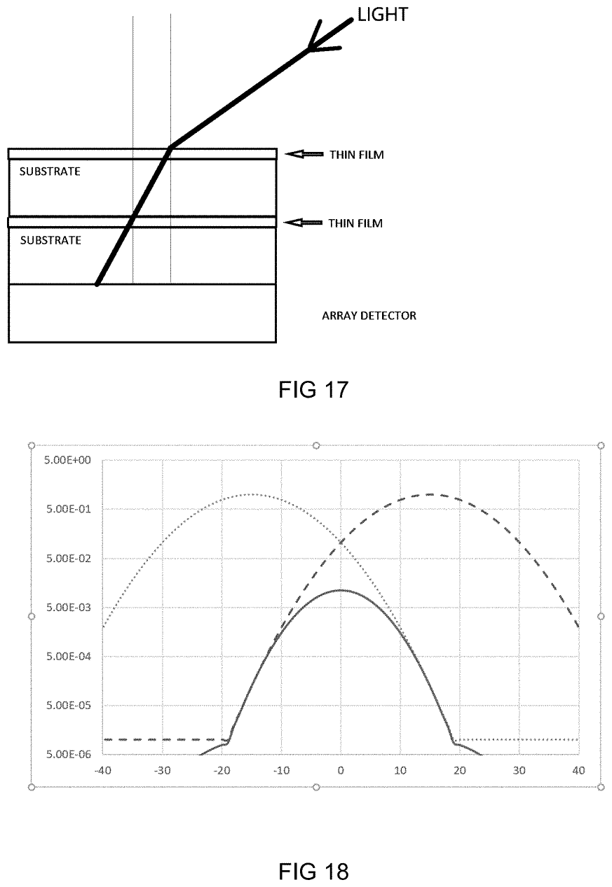

Off-axis illumination, which is mostly parallel to, and not affected by the various baffling methods between the LVBF segments, stacking of two or more identical and aligned LVBFs as described above and in FIGS. 6 and 8 can reduce sensitivity to off-axis radiation. FIG. 18 illustrates that an off-axis light ray goes through two spatially displaced positions on the two aligned LVBFs; and by extension, locations where the peak transmission may be markedly different. FIG. 17 models how the transmission function at each location on the thin LVBFs is different and the composite transmission function (solid line) through both filters is greatly attenuated. For aligned and identical LVBFs, the light rays that are more normal to the assembly will have the same peak wavelength transmission through both filters (FIGS. 13 and 14) and light propagation be minimally attenuated.

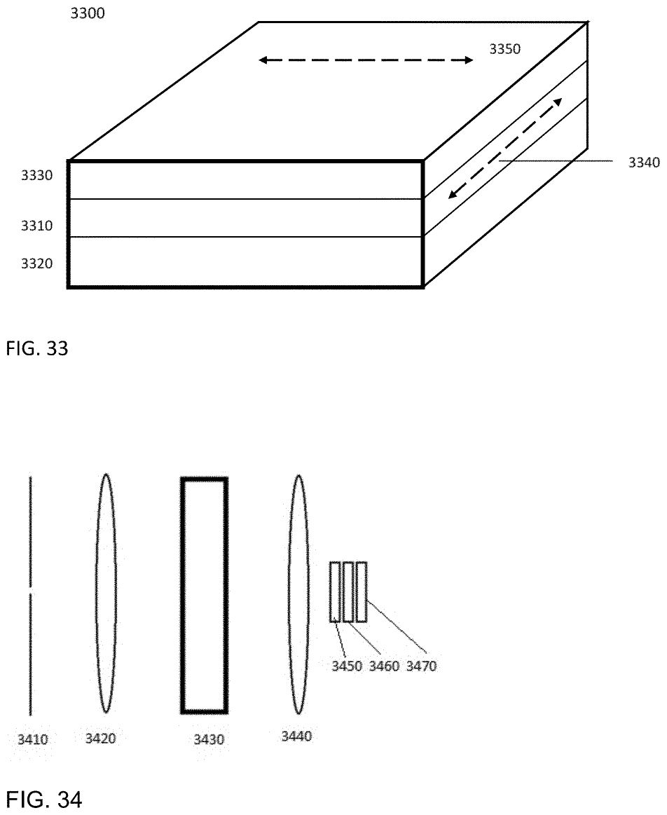

In another embodiment a device 3300 (FIG. 33) comprised of an LVBF 3310 that is bonded to an array sensor 3320 and a neutral density filter 3330, wherein the spectral bandpass direction 3340 of the LVBF is perpendicular to the columns (not shown) of the array sensor 3320. The attenuation of the neutral density filter 3330 varies in the direction 3350, which is parallel to the columns, and hence perpendicular to the rows, of array sensor 3320. Thus, while the spectral irradiance incident upon an individual pixel in a column of the sensor may be outside of its dynamic range, the same irradiance incident upon the column of pixels may be within the dynamic range of at least a subset of the column pixels.

In another embodiment of the invention includes a combination of a dispersive spectrometer and a filtered detector array assembly (FIG. 34). In this embodiment, the incident light: enters the slit 3410; is collimated by the focusing element(s) 3420, which may include a series of lens elements; is dispersed by the diffraction grating 3430; further focused by additional focusing element(s) 3440, which may include a series of lens elements; is filtered by the absorbing filter(s) 3450 and LVBF filters 3460; and finally reaches the optical detector arrays, 3470. The absorbing filter 3450 has the property that it is not uniform over the optical paths to the detector. The additional LVBF increases the stray light performance of the spectrometer. The addition of the varying attenuation filter provides a wider range of sensitivities for the pixels in any column of the detector array.

In one embodiment of the apparatus, the absorbing filter 3450 is an array of two or more filter sections which have different amounts of light absorbance.

In another embodiment, the absorbing filter 3450 may be a thin film variable density filter.

In another embodiment (not shown), the varying attenuating attributes of the absorbing filters 3450 may be printed or patterned directly onto the LVBF 3460 or the detector 3470.

In another embodiment, the absorbing filter 3450 is between the LVBF 3460 and the detector 3470.

The absorbing filter 3430 may be a dispersive element which may include a transmissive or reflective diffraction grating. The focusing elements 3420 and 3440 may have multiple elements and may be a combination of transmissive or reflective optics.

A particular advantage of the LVBF spectrometer assembly in comparison to a diffraction grating spectrometer is that the assembly has an aperture that is determined by the spectral gradient and FWHM bandpass in one direction and the width in the other of the LVBF segments. For example, if the LVBF filter prior to dicing has a spectral range of 300 nm and a length of 60 mm, the spectral gradient is 5 nm per mm. Assuming a 12 mm×12 mm (half-inch) CMOS sensor, this LVBF filter could be diced into five segments measuring 12 mm×2 mm, each with a spectral range of 60 nm. Assuming an average bandpass of 8 nm over this range, the effective area of the virtual slit is approximately 1.6 mm×2.0 mm or 3.2 mm². This may be compared to the slit width of a grating spectrometer with an equivalent FWHM bandpass, which is typically on the order of 20 to 100 μm, and an effective a detector height of 20 μm to 2.5 mm, or up to 0.25 mm². Based upon detector area alone, the optical throughput (and hence the sensitivity) of the LVBF spectrometer is therefore at least fifteen times greater than a large detector grating array spectrometer.

Another advantage of an LVBF spectrometer is that the peak transmission of LVBF segments can be selected to be in excess of 80% for all wavelengths. By comparison, grating spectrometers typically have poor grating efficiency at the top and bottom of their spectral ranges. They are also limited to approximately one and a half wavelength octaves (400 nm to 1000 nm for example), whereas the spectral range of an LVBF spectrometer is limited only by the spectral range of its 2D photodetector array (as much as 200-1050 nm for back-thinned silicon or UV enhanced silicon-based CCD or CMOS photodetector arrays).

Another disadvantage of grating spectrometers for many applications is that they are polarization sensitive. To overcome this issue, the input light usually needs to be scrambled before reaching the grating. LVBF spectrometers are not inherently polarization dependent.

Another advantage of an LVBF spectrometer is that the stray light suppression can be as good as 10E-5 for a single LVBF stack and 10E-10 for a two-layer stack—and at all wavelengths. By comparison, only the most expensive ($40,000) array detector-based grating spectrometers can match 10E-5 at the center of their spectral range. And, typically those array detector-based instruments will have much degraded stray light performance at the shortest wavelengths of their range. Even much more expensive, slow, scanning double monochromator spectrometers cannot match the 10E-10 stray light performance across any wavelength range.

Yet another advantage of an LVBF spectrometer is that the assembly can be glued together, (filters, baffles and array detector) in a compact and rugged assembly as compared to a grating spectrometer that typically has many components mounted in free space that require precise mechanical alignment and system characterization.

### Calibration

Grating-based array spectrometers and existing one-filter LVBF spectrometers are calibrated as a 1×N array where whole columns of the measurement pixels are considered to have identical spectral responsivity and are averaged together either in software or on board the camera. This method works if the LVBF is not varying spectral transmission properties in only one dimension, i.e. all of the pixels in a column have the same peak wavelength response. This is not necessarily the case for the embodiments of a multi-segment LVBF spectrometer as described above.

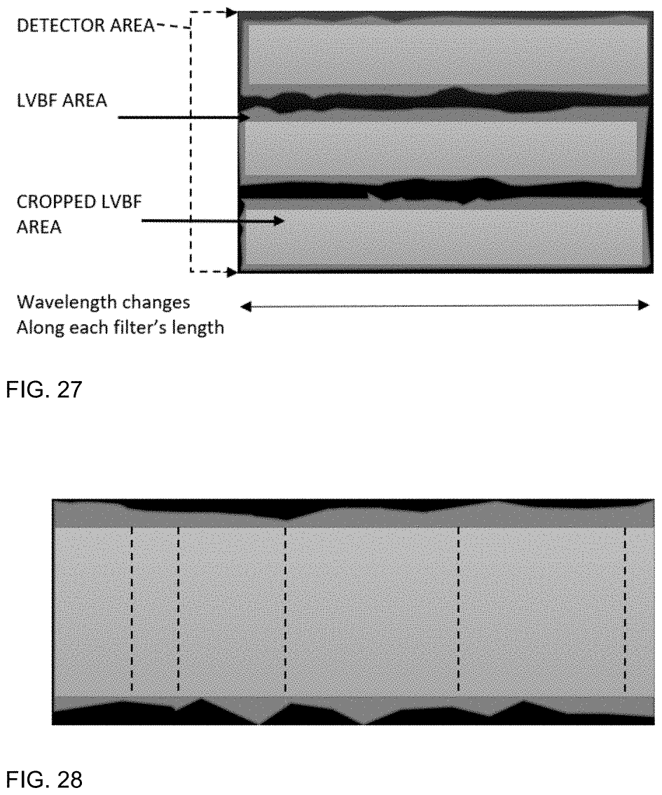

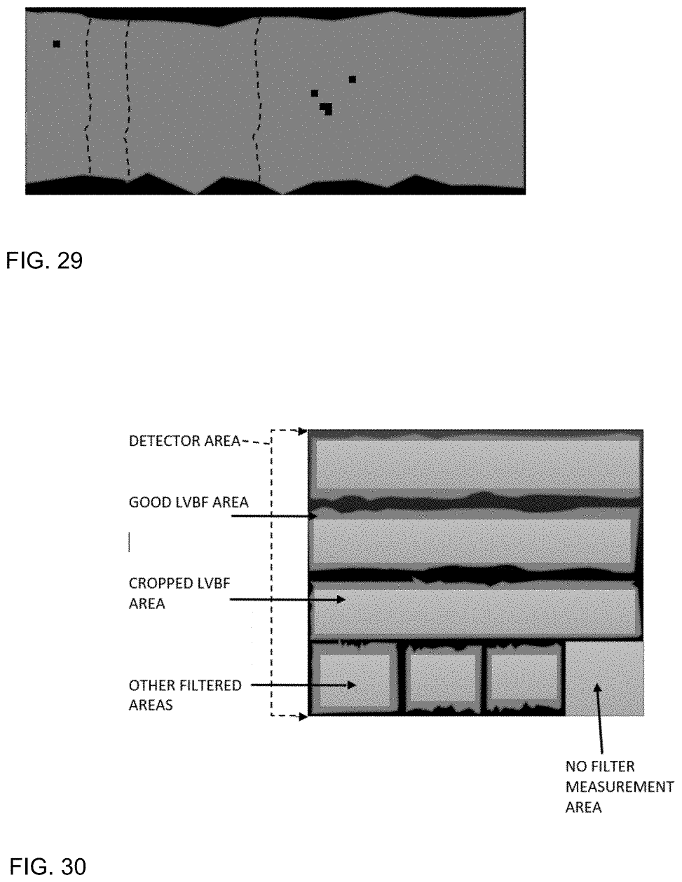

FIGS. 27, 28 and 29 show how a multi-segment LVBF spectrometer could be modeled and mapped for wavelength. The black areas are pixel sensor areas where the LVBF is not performing to specification. The dark gray area is where the LVBF is within specification and the light gray area is rectangular region that excludes the bad areas in the perimeter. The calibration of the multi-segment LVBF spectrometer of N photodetector elements long could be considered as a multitude of 1×N arrays where the columns of pixels in each segment are summed or averaged. The smaller rectangular areas in FIG. 27 are cropped in length and width to exclude bad perimeter areas and are N pixels in length. Alternatively, if the segments did not have very predictable peak wavelengths along the length of the segment, then the wavelength determination for each pixel could be determined uniquely, and not on a per-column basis. The calibration processes outlined in FIGS. 28 and 29 include a method to locate and map any number of pixel response defects such as bad bandwidth, bad peak transmission (signal to noise), bad stray light, and bad spectral transmission shape. Once mapped, these pixels with defects are excluded from all future measurements.

FIG. 30 illustrates an LVBF assembly with a plurality of LVBF segments and some additional measurement areas on the sensor for other filtered light measurements and an area on the sensor that is dedicated to detecting the light without any additional light filtering.

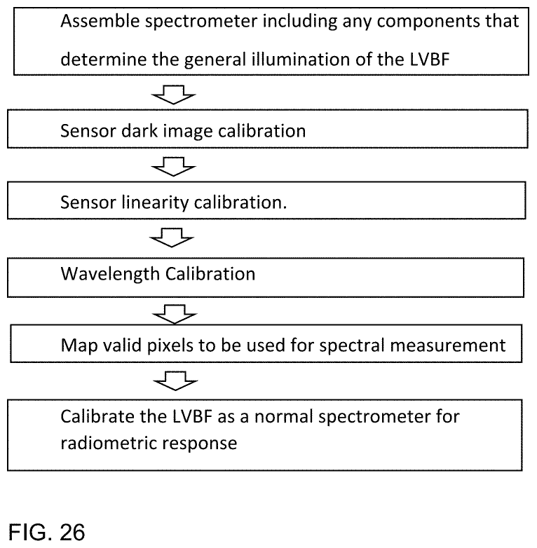

FIG. 26 describes the general process to calibrate a LVBF spectrometer. During the Dark Image Calibration and Linearity Calibration steps in this process any photodetector elements that are outside the tolerance are logged as invalid and not to be used in further calibration steps or in subsequent measurements.

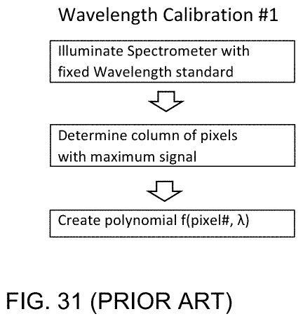

FIG. 31 describes a prior art process to perform the wavelength calibration of an LVBF spectrometer as a plurality of 1×N arrays using a multitude of monochromatic wavelengths.

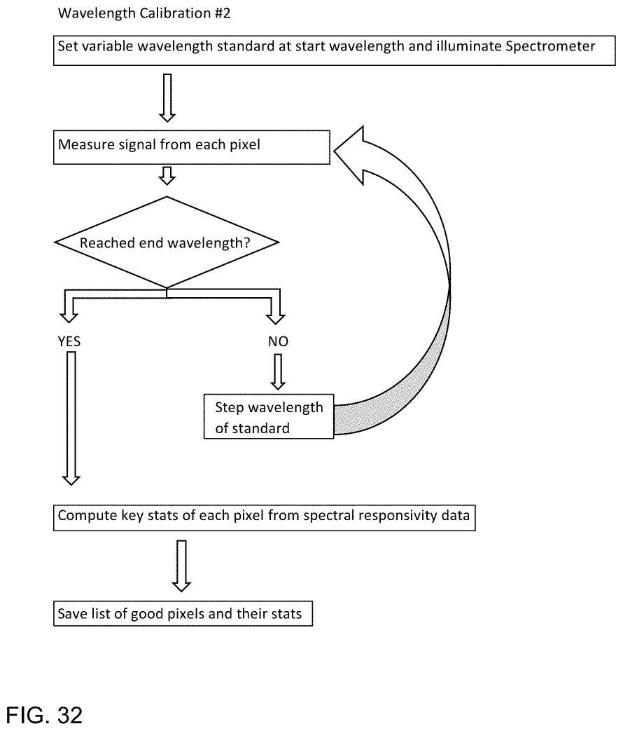

FIG. 32 describes a method to calibrate the LVBF spectrometer wherein the wavelength values (peak or centroid) for detector regions (pixels or aggregates of pixels) are not mapped in columns.
a. The process starts by illuminating the spectrometer with stabilized light from a continuously variable light source such as the output of a monochromator or a tunable laser. The start and stop wavelengths of the stepped illuminating light source should be a few percent above and below the range of the spectrometer if peak wavelength and centroid wavelength and bandwidth are all to be calculated for the pixels in the spectrometer. For example, for a typical 400 nm-1000 nm spectrometer, the start and stop wavelengths of the illumination could be 388 and 1030 nm.
b. The signal from each pixel is measured and saved in an array. HDR (high dynamic range) measurement is recommended, as the spectrometer dynamic range can be very high.
c. The wavelength is stepped and b) is repeated until the stop wavelength is repeated. The stepping interval of the process should be less than half the expected FWHM bandwidth at any pixel to have a fair estimation of where the peak and centroid wavelengths are. A sampling interval of approximately one-fifth the bandwidth will yield more accurate estimations of the peak and centroid wavelengths as well as the value of FWHM bandwidth. Sampling at much smaller intervals than one-fifth may improve the data, but also increase the total measurement time and data file sizes.
d. Once the scan has reached the end wavelength, there are measurements of each pixel's signal from the start to stop wavelength. Using standard processes, the important statistics such as peak wavelength, centroid wavelength, FWHM bandwidth and out of band rejection can be calculated.
e. Additional measurements of the detector's response at wavelengths below and above the original start-stop range in a) above, may also be measured to ensure the out-of-band leakage for all pixels is also within tolerances. It is not necessary to measure wavelengths of light which have no responsivity in the detector. If a phosphor or quantum dot coating is used in the LVBF spectrometer, then the range of the detector is extended by the additional excitation range of the phosphors or quantum dots.
f. Any photodetector elements with out of tolerance values for peak wavelength, centroid wavelength, FWHM bandwidth, stray light (out of band rejection), sensitivity, or any other critical parameter are logged in the calibration file as invalid elements, and are not to be used further in the calibration or in subsequent measurements.
g. The wavelength illumination stepping in a) to e) above can also be from longer to shorter wavelengths.
h. If the light source used to illuminate the LVBF spectrometer is not stable, then the resulting data will have degraded precision. There are methods to correct or mitigate illumination instability such as:
   i. Monitoring the illumination via a second calibrated detector and using the value of that second detector to normalize the results to compensate for illumination instability.
   ii. Taking multiple averages of measurements at each illumination wavelength.
   iii. Adjusting the illumination level as required to ensure the integration time of the detector pixels is always much longer than the period of the illumination source. Some tunable lasers are pulsed.

i. The method above where rectangular regions of pixels are mapped out as pixels to be calibrated before steps a) to g) above. See FIG. 27.

j. The method above where columns of pixels are summed or averaged to yield a single spectral response value for each column of pixels in the rectangular regions in h). See FIG. 28.

k. The method of i) which is simplified to only measure only measure peak response at a few wavelengths over the range of the LVBF spectrometer. In this case, the column with the maximum value at the illuminating wavelength. Or, the column of pixels closest to the peak wavelength is fit to the expected wavelength, but not necessarily to the exact peak. Given just a few or several wavelengths mapped, a polynomial function is applied to describe the pixel column versus wavelength relationship.
l. The method of j) where columns of pixels are not averaged or summed, but rather, each row of pixels in the rectangular region in h) is evaluated to determine the peak wavelength of a pixel in each row uniquely—and not on a column by column basis. In this case, pixels in rows of the same peak wavelength may not necessarily form linear columns. See FIG. 29. The wavelength values for pixels in a row are fit with a polynomial function.

While some advantages of the invention have been described, it is not to be implied that any particular embodiment possesses all of the advantages.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. All parameters, dimensions, materials, and configurations described herein are examples only and actual values of such depend on the specific embodiment. Accordingly, the specification is to be regarded in an illustrative, rather than a restrictive, sense.

The embodiments of the invention may be varied in many ways. Such variations are not to be regarded as a departure from the spirit and scope of the invention, and all such modifications as would be obvious to one skilled in the art are intended to be included within the scope of the claims.

### CLAIM SUPPORT

Disclosed is an apparatus comprising a spectrometer with an extended spectral range coupled to two or more linear variable bandpass filters; and optically coupled to a two-dimensional photodetector array.

In some embodiments, the spectrometer is a compact spectrometer.

Disclosed is an apparatus comprising a spectrometer with an extended spectral range coupled to two or more linear variable bandpass filters arranged in a stacked geometry and optically coupled to a two-dimensional photodetector array.

Disclosed is a method to reduce stray light in a spectrometer utilizing two or more variable bandpass filters and a two-dimensional photodetector array.

Disclosed is a method to reduce a spectrometer's full-width-half-maximum spectral bandwidth utilizing two or more variable bandpass filters and a two-dimensional photodetector array.

Disclosed is a detector for a dispersive spectrometer comprising an array detector optically coupled to one or more linear variable bandpass filters and one or more attenuating density filters.

Disclosed is a spectrometer comprising: a segmented linear variable bandpass filter (“LVBF”) having a plurality of segments each with a different spectral range, the segments providing the spectrometer with an extended spectral range; and an optical detector array located to detect optical radiation passing through the LVBF.

In some embodiments, the segments have overlapping spectral ranges and the extended spectral range is continuous. In some embodiments, the segments have non-overlapping spectral ranges and the extended spectral range is discontinuous.

In some embodiments, the segments are bonded together with a transparent adhesive or with an opaque adhesive. In some embodiments, the segments are separated with an air gap, a vacuum gap, or an index matching fluid.

In some embodiments, the spectrometer comprises a further LVBF stacked on the LVBF. In some embodiments, the LVBF and further LVBF each have a peak transmission wavelength and the LVBF and further LVBF are misaligned to offset their peak transmission wavelengths.

In some embodiments, baffles are located between the segments to block light that is travelling at oblique incident angles towards the segments.

In some embodiments, a further LVBF is arranged side-by-side with the LVBF, the LVBF and further LVBF having different spectral transmittance functions from each other.

In some embodiments, one or more optical filters are bonded to one or more of the segments. In some embodiments, the one or more optical filters comprise one or more of: dyed glass; a semitransparent metal film, glass or polymer substrate; a linear polarizer; a polarization retarder; a long-pass filter; a short-pass filter; an antireflection coating; or a spatially-varying attenuator.

In some embodiments, there is a UV enhancement layer between the optical detector array and one or more of the segments, the UV enhancement layer converting UV to longer wavelength radiation. In some embodiments, the UV enhancement layer comprises a phosphor or quantum dots and is: a separate sheet between the segments and the optical detector array; a coating or film on the segments; or a coating or film on the optical detector array.

In some embodiments, there is an IR enhancement layer between the optical detector array and one or more of the segments, the IR enhancement layer upconverting IR to shorter wavelength radiation. In some embodiments, the IR enhancement layer comprises a phosphor or quantum dots and is: a separate sheet between the segments and the optical detector arrays; a coating or film on the segments; or a coating or film on the optical detector array.

In some embodiments, the spectrometer is optically coupled to: a fiber optic cable; a light guide; an integrating sphere; or an optical train assembly such that optical radiation incident upon the segments is substantially collimated. In some embodiments, the spectrometer comprises: a plate defining an entry slit; a first set of one or more focusing elements to collimate optical radiation passing through the slit; a diffraction grating to disperse the collimated light; a second set of one or more focusing elements to focus the dispersed light; and one or more absorbing filters between either the second set of focusing elements and the LVBF or the LVBF and the optical detector array; wherein the one or more absorbing filters are non-uniform over optical paths to the optical detector array.

In some embodiments, the spectrometer comprises a plate defining an entry slit; a concave and reflecting diffraction grating to disperse optical radiation passing through the entry slit; and one or more absorbing filters that are non-uniform over optical paths to the optical detector array; wherein at least some of the optical radiation is focused on the optical detector array.

In some embodiments, the one or more absorbing filters: comprise an array of two or more filter sections which have different amounts of light absorbance; are one or more thin film variable density filters; are printed or patterned directly onto the segments and have varying attenuation; are printed or patterned directly onto the optical detector array and have varying attenuation; or are one or more non-variable density filters.

In some embodiments, the diffraction grating is a transmissive diffraction grating or a reflective diffraction grating; the first set comprises more than one focusing element and includes a combination of transmissive or reflective optics; and the second set comprises more than one focusing element and includes a further combination of transmissive or reflective optics.

In some embodiments, the spectrometer comprises a further LVBF on the LVBF, the further LVBF tilted with respect to the LVBF.

Disclosed is a spectrometer comprising: a segmented linear variable bandpass filter (“LVBF”) having a plurality of segments each with a different spectral range, the segments providing the spectrometer with a composite spectral range that is longer than each spectral range of the segments; and an optical detector array located to detect optical radiation passing through the LVBF.

Disclosed is a spectrometer comprising a segmented linear variable bandpass filter (“LVBF”) having a plurality of segments each with the same spectral range; and an optical detector array located to detect optical radiation passing through the LVBF. The segments are different in optical opacity.

In some embodiments, a light enhancement layer is between the optical detector array and one or more of the segments, wherein the light enhancement layer upconverts or downconverts light to shorter or longer wavelength radiation respectively.

I claim:

1. A spectrometer comprising:
a segmented linear variable bandpass filter (“LVBF”) having a plurality of segments each with a different spectral range, the segments providing the spectrometer with a composite spectral range that is longer than each spectral range of the segments; and
an optical detector array located to detect optical radiation passing through the LVBF.

2. The spectrometer of claim 1, wherein the segments have overlapping spectral ranges and the composite spectral range is continuous.

3. The spectrometer of claim 1, wherein the segments have non-overlapping spectral ranges and the composite spectral range is discontinuous.

4. The spectrometer of claim 1, wherein the segments are arranged in a 2-dimensional manner such that there are disparate wavelengths associated with a significant portion of the optical detector array.

5. The spectrometer of claim 1, wherein the segments are bonded together with a transparent adhesive or with an opaque adhesive.

6. The spectrometer of claim 1, wherein the segments are separated with an air gap, a vacuum gap, or an index matching fluid.

7. The spectrometer of claim 1, comprising a further LVBF stacked on the LVBF.

8. The spectrometer of claim 7, wherein the LVBF and further LVBF each have a peak transmission wavelength and the LVBF and further LVBF are misaligned to offset their peak transmission wavelengths.

9. The spectrometer of claim 1, comprising baffles located between the segments to block light that is travelling at oblique incident angles towards the segments.

10. The spectrometer of claim 1, comprising a further LVBF arranged side-by-side with the LVBF, the LVBF and further LVBF having different spectral transmittance functions from each other.

11. The spectrometer of claim 1, comprising one or more optical filters bonded to one or more of the segments.

12. The spectrometer of claim 11, wherein the one or more optical filters comprise one or more of:
dyed glass;
a semitransparent metal film, glass or polymer substrate;
a linear polarizer;
a polarization retarder;
a long-pass filter;
a short-pass filter;
an antireflection coating; or
a spatially-varying attenuator.

13. The spectrometer of claim 1, comprising a UV enhancement layer between the optical detector array and one or more of the segments, the UV enhancement layer converting UV to longer wavelength radiation.

14. The spectrometer of claim 13 wherein the UV enhancement layer comprises a phosphor or quantum dots and is:
a separate sheet between the segments and the optical detector array;
a coating or film on the segments; or
a coating or film on the optical detector array.

15. The spectrometer of claim 1, comprising a light enhancement layer between the optical detector array and one or more of the segments, wherein the light enhancement layer upconverts or downconverts light to shorter or longer wavelength radiation respectively.

16. The spectrometer of claim 15, wherein the IR enhancement layer comprises a phosphor or quantum dots and is:
a separate sheet between the segments and the optical detector arrays;
a coating or film on the segments; or
a coating or film on the optical detector array.

17. The spectrometer of claim 1 optically coupled to:
a fiber optic cable;
a light guide;
an integrating sphere; or
an optical train assembly such that optical radiation incident upon the segments is substantially collimated.

18. The spectrometer of claim 1 comprising:
a plate defining an entry slit;
a first set of one or more focusing elements to collimate optical radiation passing through the slit;
a diffraction grating to disperse the collimated light;
a second set of one or more focusing elements to focus the dispersed light; and
one or more absorbing filters between either the second set of focusing elements and the LVBF or the LVBF and the optical detector array;
wherein the one or more absorbing filters are non-uniform over optical paths to the optical detector array.

19. The spectrometer of claim 1 comprising:
a plate defining an entry slit;
a concave and reflecting diffraction grating to disperse optical radiation passing through the entry slit; and
one or more absorbing filters that are non-uniform over optical paths to the optical detector array;
wherein at least some of the optical radiation is focused on the optical detector array.

20. The spectrometer of claim 19 wherein the one or more absorbing filters:
comprise an array of two or more filter sections which have different amounts of light absorbance;
are one or more thin film variable density filters;
are printed or patterned directly onto the segments and have varying attenuation;
are printed or patterned directly onto the optical detector array and have varying attenuation; or
are one or more non-variable density filters.

21. The spectrometer of claim 19 wherein:
the diffraction grating is a transmissive diffraction grating or a reflective diffraction grating;
the first set comprises more than one focusing element and includes a combination of transmissive or reflective optics; and
the second set comprises more than one focusing element and includes a further combination of transmissive or reflective optics.

22. The spectrometer of claim 1, comprising a further LVBF on the LVBF, the further LVBF tilted with respect to the LVBF.
